(19) United States
(12) Patent Application Publication
(10) Pub. No.: US 2026/0299923 A1
(43) Pub. Date: Oct. 1, 2026

(54) VEHICLE-MOUNTED APPARATUS, UPDATING METHOD, AND UPDATING PROGRAM

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Takuya KOBAYASHI, Yokkaichi-shi, Mie (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 19/476,237

(22) PCT Filed: Apr. 2, 2024
(86) PCT No.: PCT/JP2024/013585

§ 371 Date: Oct. 17, 2025

(30) Foreign Application Priority Data
Apr. 20, 2023 (JP) 2023-069206

(51) Int. Cl. G06F 8/65

(52) U.S. Cl. CPC G06F 8/65

(57) ABSTRACT

A vehicle-mounted apparatus includes: a storage unit including a first logical area and a second logical area; first software that is stored in the first logical area and is capable of transmitting and receiving data to and from the vehicle-mounted network; second software that is stored in the second logical area; an updating unit that updates the second software; and an inter-area communication unit that is capable of transmitting and receiving data to and from the first logical area and is also capable of transmitting and receiving data to and from the second logical area. The inter-area communication unit receives update data, which a data communication unit implemented by a processor executing the first software has received from the vehicle-mounted network, from the data communication unit and passes the received update data to the updating unit. The updating unit updates the second software based on the update data.

### CROSS-REFERENCE TO RELATED APPLICATIONS

This application is the U.S. national stage of PCT/JP2024/013585 filed on Apr. 2, 2024, which claims priority of Japanese Patent Application No. JP 2023-069206 filed on Apr. 20, 2023, the contents of which are incorporated herein.

### TECHNICAL FIELD

The present disclosure relates to a vehicle-mounted apparatus, an updating method, and an updating program.

### BACKGROUND

Vehicles are equipped with various types of vehicle-mounted apparatus, such as control system electronic control units (ECUs) that control the engine, transmission, and the like, body system ECUs that control the headlights, power windows, and the like, and information system ECUs for a navigation apparatus, multimedia devices, and the like.

JP 2022-173923A discloses a vehicle-mounted relay apparatus including a first central processing unit (CPU) and a second CPU. The first CPU is cut off from a vehicle-mounted network 2 provided inside the vehicle, and performs communication with outside the vehicle. The second CPU is cut off from the outside of the vehicle and is connected so as to communicate with the vehicle-mounted network. By including the first CPU and the second CPU that are physically separated, the vehicle-mounted relay apparatus disclosed in JP 2022-173923A improves security by providing a multi-layered defense against attacks from outside the vehicle on the vehicle-mounted network.

However, the vehicle-mounted relay device disclosed in JP 2022-173923A requires two CPUs, resulting in the problem of a large number of parts and an increase in product cost.

### SUMMARY

A vehicle-mounted apparatus according to an aspect of the present disclosure is connected to a vehicle-mounted network and includes: a storage unit including a first logical area and a second logical area which are logically separated from each other and are subjected to restrictions on data transfers; first software that is stored in the first logical area and is capable of transmitting and receiving data to and from the vehicle-mounted network; second software that is stored in the second logical area and is subjected to restrictions on transmitting and receiving data to and from the vehicle-mounted network; an updating unit that updates the second software; and an inter-area communication unit that is capable of transmitting and receiving data to and from the first logical area and is also capable of transmitting and receiving data to and from the second logical area, wherein the inter-area communication unit receives update data, which a data communication unit implemented by a processor executing the first software has received from the vehicle-mounted network, from the data communication unit and passes the received update data to the updating unit, and the updating unit updates the second software based on the update data passed from the inter-area communication unit.

### Advantageous Effects

According to the present disclosure, it is possible to ensure security while suppressing the number of parts in a vehicle mounted apparatus.

### BRIEF DESCRIPTION OF DRAWINGS

FIG. 1 is a block diagram depicting an example configuration of a vehicle-mounted network according to a first embodiment.

FIG. 2 is a block diagram depicting an example hardware configuration of an ECU according to the first embodiment.

FIG. 3 is a block diagram depicting an example configuration of a nonvolatile memory installed in an ECU according to the first embodiment.

FIG. 4 is a diagram depicting the configuration of partitions in the nonvolatile memory according to the first embodiment.

FIG. 5 is a diagram illustrating an example of a data flow in an ECU according to the first embodiment.

FIG. 6 is a diagram illustrating another example of a data flow in an ECU according to the first embodiment.

FIG. 7 is a diagram illustrating an example data flow when updating first software in an ECU according to the first embodiment.

FIG. 8 is a diagram illustrating updating of the first software in an ECU according to the first embodiment.

FIG. 9 is a diagram illustrating an example data flow when updating second software in an ECU according to the first embodiment.

FIG. 10 is a diagram illustrating the updating of second software in an ECU according to the first embodiment.

FIG. 11 is a sequence chart depicting data flows on a vehicle-mounted network when the second software is updated at an ECU according to the first embodiment.

FIG. 12 is a flowchart depicting an example operation of an ECU according to the first embodiment when the ECU updates the second software.

FIG. 13 is a block diagram depicting an example configuration of a nonvolatile memory installed in an ECU according to a second embodiment.

FIG. 14 is a diagram depicting the configuration of partitions in a nonvolatile memory according to the second embodiment.

FIG. 15 is a diagram depicting the operating state of software when an application to be executed is switched between first application software and second application software.

FIG. 16 is a block diagram depicting an example configuration of a nonvolatile memory installed in an ECU according to a third embodiment.

### DETAILED DESCRIPTION OF PREFERRED EMBODIMENTS

Embodiments of the present disclosure will first be listed and described in outline.

In a first aspect, a vehicle mounted apparatus according to an aspect of the present disclosure is a vehicle-mounted apparatus connected to a vehicle-mounted network, including: a storage unit including a first logical area and a second logical area which are logically separated from each other and are subjected to restrictions on data transfers; first software that is stored in the first logical area and is capable of transmitting and receiving data to and from the vehicle-mounted network; second software that is stored in the second logical area and is subjected to restrictions on transmitting and receiving data to and from the vehicle-mounted network; an updating unit that updates the second software; and an inter-area communication unit that is capable of transmitting and receiving data to and from the first logical area and is also capable of transmitting and receiving data to and from the second logical area, wherein the inter-area communication unit receives update data, which a data communication unit implemented by a processor executing the first software has received from the vehicle-mounted network, from the data communication unit and passes the received update data to the updating unit, and the updating unit updates the second software based on the update data passed from the inter-area communication unit. By doing so, it is possible to install the first software and the second software in the vehicle-mounted apparatus without providing redundant hardware in the vehicle-mounted apparatus, which makes it possible to suppress the number of parts in the vehicle-mounted apparatus. In addition, security can be ensured by placing the first software and the second software in a first logical area and a second logical area that are logically separated and enabling data to be exchanged between the first software and the second software only by the inter-area communication unit.

In a second aspect, in the vehicle-mounted apparatus according to the first aspect, the updating unit may be implemented by the processor executing updating software stored in the second logical area. By doing so, it is possible to ensure even higher security by placing the update software in the second logical area for which transmission and reception of data directly to and from the vehicle-mounted network are restricted.

In a third aspect, in the vehicle-mounted apparatus according to the second aspect, the updating unit may be capable of updating the first software. By doing so, even when the first software is updated, data is exchanged via the inter-area communication unit, which makes it possible to ensure high security.

In a fourth aspect, in the vehicle-mounted apparatus according to the first aspect, the updating unit may include a first updating unit that updates the first software and a second updating unit that updates the second software, the first updating unit may be implemented by the processor executing the first updating software stored in the first logical area, and the second updating unit may be implemented by the processor executing the second updating software stored in the second logical area. By doing so, when the first software is updated, there is no need to send and receive data via the inter-area communication unit, which makes it possible to reduce the processing load. When updating the second software, update data is sent and received via the inter-area communication unit, which makes it possible to ensure high security.

In a fifth aspect, in the vehicle-mounted apparatus according to the fourth aspect, the first updating unit may receive, from the data communication unit, first update data that was received by the data communication unit from the vehicle-mounted network, and update the first software based on the received first update data. By doing so, the first update unit is prevented from directly receiving the first update data from the vehicle-mounted network, which makes it possible to improve security.

In a sixth aspect, the vehicle-mounted apparatus according to any one of the first to the fifth aspects, the storage unit may include a first storage unit and a second storage unit that are physically separated, the inter-area communication unit may include a first inter-area communication unit that is implemented by the processor executing first management software stored in the first storage unit and a second inter-area communication unit that is implemented by the processor executing second management software stored in the second storage unit, the first inter-area communication unit may operate while the second inter-area communication unit is stopped, and the second inter-area communication unit may operate while the first inter-area communication unit is stopped. With this configuration, by switching between the operation of the first inter-area communication unit and the operation of the second inter-area communication unit, it is possible to shorten or eliminate a period during which the operation of the inter-area communication unit is stopped.

In a seventh aspect, in the vehicle-mounted apparatus according to the sixth aspect, the first inter-area communication unit may operate while the second management software is being updated, and the second inter-area communication unit may operate while the first management software is being updated. By doing so, it is possible, while the first management software or the second management software is being updated, to shorten or eliminate the period during which the operation of the inter-area communication unit is stopped.

In an eighth aspect, in the vehicle-mounted apparatus according to the sixth or the seventh aspect, the storage unit may include a third logical area that is logically separated from each of the first logical area and the second logical area and is subjected to restrictions on data transfers to and from each of the first logical area and the second logical area, and the first management software and the second management software may be stored in the third logical area. By doing so, the first management software and the second management software can be logically separated from the first software and the second software, which further improves security.

In a ninth aspect, in the vehicle-mounted apparatus according to any one of the sixth to the eight aspect, the first logical area may include a first partial area of the first storage unit and a first partial area of the second storage unit, the second logical area may include a second partial area of the first storage unit and a second partial area of the second storage unit, the first software may be stored in both the first partial area of the first storage unit and the first partial area of the second storage unit, the first software stored in the first partial area of the second storage unit may be stopped while the first software stored in the first partial area of the first storage unit is being executed, and the first software stored in the first partial area of the first storage unit may be stopped while the first software stored in the first partial area of the second storage unit is being executed. By doing so, it is possible to shorten or eliminate the period during which the first software is stopped.

In a tenth aspect, in the vehicle-mounted apparatus according to the ninth aspect, the first software stored in the first partial area of the second storage unit may be executed while the first software stored in the first partial area of the first storage unit is being updated, and the first software stored in the first partial area of the first storage unit may be executed while the first software stored in the first partial area of the second storage unit is being updated. By doing so, it is possible to shorten or eliminate the period during which the first software is stopped while the first software is being updated.

In an eleventh aspect, in the vehicle-mounted apparatus according to the ninth aspect, the second software may be stored in both the second partial area of the first storage unit and the second partial area of the second storage unit, the second software stored in the second partial area of the second storage unit may be stopped while the second software stored in the second partial area of the first storage unit is being executed, and the second software stored in the second partial area of the first storage unit may be stopped while the second software stored in the second partial area of the second storage unit is being executed. By doing so, it is possible to shorten or eliminate the period during which the second software is stopped.

In a twelfth aspect, in the vehicle-mounted apparatus according to the eleventh aspect, the second software stored in the second partial area of the second storage unit may be executed while the second software stored in the second partial area of the first storage unit is being updated, and the second software stored in the second partial area of the first storage unit may be executed while the second software stored in the second partial area of the second storage unit is being updated. By doing so, it is possible to shorten or eliminate the period during which the second software is stopped while the second software is being updated.

In a thirteenth aspect, in the vehicle-mounted apparatus according to any one of the first to the twelfth aspects, the data communication unit may have a first defense function that defends against external attacks, and a data transfer unit implemented by the processor executing the second software may have a second defense function that defends against external attacks. By doing so, high security can be ensured by the first defense function and the second defense function. For the second software in particular, a two-stage defense function, composed of the first defense function and the second defense function, operates when data is received from the vehicle-mounted network, so that even higher security can be ensured.

In a fourteenth aspect, an updating method according to an aspect of the present disclosure is an updating method for updating software in a vehicle-mounted apparatus connected to a vehicle-mounted network, including: a step of receiving update data, which has been received from the vehicle-mounted network by a data communication unit implemented by a processor executing first software, which is stored in a first logical area provided in a storage unit and is capable of transmitting and receiving data to and from the vehicle-mounted network, using an inter-area communication unit capable of transmitting and receiving data to and from the first logical area; a step of the inter-area communication unit passing the update data to an updating unit that updates second software stored in a second logical area, which is provided in the storage unit and is logically separated from the first logical area, the second software being subjected to restrictions on transmitting and receiving data to and from the vehicle-mounted network; and a step of the updating unit updating the second software based on the update data passed from the inter-area communication unit. By doing so, it is possible to install the first software and the second software in a vehicle-mounted apparatus without providing redundant hardware in the vehicle-mounted apparatus, which makes it possible to suppress the number of parts in the vehicle-mounted apparatus. In addition, security can be ensured by placing the first software and the second software in a first logical area and a second logical area that are logically separated and enabling data to be exchanged between the first software and the second software only by the inter-area communication unit.

In a fifteenth aspect, an updating program according to an aspect of the present disclosure is an updating program for updating software in a vehicle-mounted apparatus connected to a vehicle-mounted network, the updating program causing a computer, which includes a storage unit including a first logical area and a second logical area which are logically separated from each other and are subjected to restrictions on data transfers, to execute processing including: a step of receiving update data, which has been received from the vehicle-mounted network by a data communication unit implemented by a processor executing first software, which is stored in the first logical area and is capable of transmitting and receiving data to and from the vehicle-mounted network, via an inter-area communication unit capable of transmitting and receiving data to and from the first logical area; and a step of updating, based on the update data received from the inter-area communication unit, second software that is stored in the second logical area and is subject to restrictions on transmitting and receiving data to and from the vehicle-mounted network. By doing so, it is possible to install the first software and the second software in a vehicle-mounted apparatus without providing redundant hardware in the vehicle-mounted apparatus, which makes it possible to suppress the number of parts in the vehicle-mounted apparatus. In addition, security can be ensured by placing the first software and the second software in a first logical area and a second logical area that are logically separated and enabling data to be exchanged between the first software and the second software only by the inter-area communication unit.

The present disclosure can be realized not only as a vehicle-mounted apparatus with the characteristic configuration described above, an updating method with steps corresponding to characteristic processes in such vehicle-mounted apparatus, and an updating program for causing a vehicle-mounted apparatus to execute the characteristic processes, but also as a vehicle-mounted system including such vehicle-mounted apparatus or a semiconductor integrated circuit that is part or all of such vehicle-mounted apparatus.

Preferred embodiments of the present disclosure are described in detail below with reference to the accompanying drawings. Note that the embodiments described below can be freely combined, at least in part.

### FIRST EMBODIMENT

### Vehicle-Mounted Network

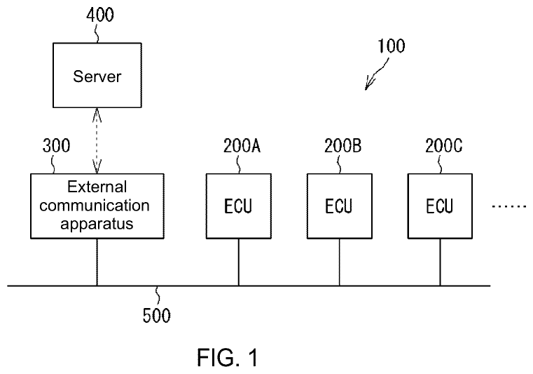

FIG. 1 is a block diagram depicting an example configuration of a vehicle-mounted network according to a first embodiment. A vehicle-mounted network 100 includes a plurality of ECUs 200A, 200B, 200C, . . . and an external communication apparatus 300.

The vehicle-mounted network 100 is composed of the ECUs 200A, 200B, 200C, . . . , the external communication apparatus 300, and communication lines (communication buses) that connect such components.

The plurality of ECUs 200A, 200B, 200C, . . . are disposed in various parts of a vehicle. The ECUs 200A, 200B, 200C, . . . individually control hardware at each part of the vehicle and/or monitor the state of the hardware at each part of the vehicle. As one example, the ECUs 200A, 200B, 200C, . . . are ECUs for a control system, a body system, and an information system. Note that in the following description, the ECUs 200A, 200B, 200C, . . . are collectively referred to as the “ECUs 200”.

The ECUs 200A, 200B, 200C, . . . are connected to each other via a communication bus 500, such as a Controller Area Network (CAN) bus. The ECUs 200 are capable of transmitting frames. A frame is a message that complies with communication protocol mentioned above.

Although not illustrated, the vehicle may include a relay ECU that relays frames between the plurality of ECUs 200. As one example, a relay ECU is connected to a plurality of communication buses and is capable of relaying frames between the communication buses.

The ECUs 200 use a communication protocol to transmit and receive messages cyclically or non-cyclically. As examples, the communication protocol is CAN or CAN FD (CAN with Flexible Data Rate). As another example, the communication protocol is Ethernet (registered trademark).

FIG. 1 depicts a vehicle-mounted network 100 for a case where the ECUs 200 and the external communication apparatus 300 use CAN protocol. That is, the vehicle-mounted network 100 depicted in FIG. 1 has a bus-based network topology. When the ECU 200 and the external communication apparatus 300 use Ethernet protocol, the network topology of the vehicle-mounted network 100 is star-shaped.

The external communication apparatus 300 is connected to the communication bus 500. The external communication apparatus 300 can transmit and receive frames to and from the ECUs 200A, 200B, 200C, . . . via the communication bus 500. As one example, the external communication apparatus 300 is a telematics control unit (TCU) and can communicate with apparatuses outside the vehicle. The external communication apparatus 300 includes a wireless communication interface for a mobile communication system, such as fifth-generation mobile communication system (5G) or fourth generation mobile communication system (4G). As one example, the external communication apparatus 300 can transmit and receive TCP/IP (Transmission Control Protocol/Internet Protocol) packets. The external communication apparatus 300 is connected to a base station (not illustrated) of the mobile communication network and can communicate via the base station with apparatuses connected to the Internet. In more detail, the external communication apparatus 300 can communicate with a server 400. The external communication apparatus 300 relays communication between the ECUs 200A, 200B, and 200C and the server 400.

The server 400 stores update data, which is used to update software of the ECUs 200. In response to a request from an ECU 200, the server 400 transmits the update data to the vehicle in which that ECU 200 is mounted (that is, to the external communication apparatus 300). The server 400 is a so-called “Over The Air (OTA) server”.

### Hardware Configuration of ECU

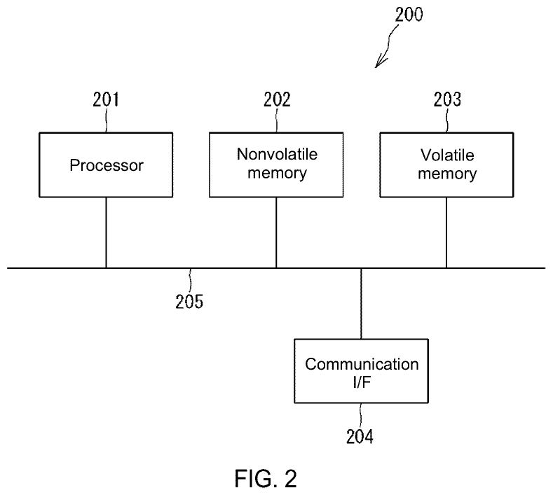

FIG. 2 is a block diagram depicting an example hardware configuration of an ECU according to the first embodiment. Each ECU 200 includes a processor 201, a nonvolatile memory 202, a volatile memory 203, and a communication interface (hereinafter, also referred to as a “communication I/F”) 204. The processor 201, the nonvolatile memory 202, the volatile memory 203, and the communication I/F 204 are connected to each other by a bus 205, which is a communication line. The processor 201, the nonvolatile memory 202, the volatile memory 203, and the communication I/F 204 can transfer data to each other via the bus 205. Each ECU 200 is one example of a “vehicle-mounted apparatus” for the present disclosure.

The volatile memory 203 is semiconductor memory, such as static random access memory (SRAM) or dynamic random access memory (DRAM).

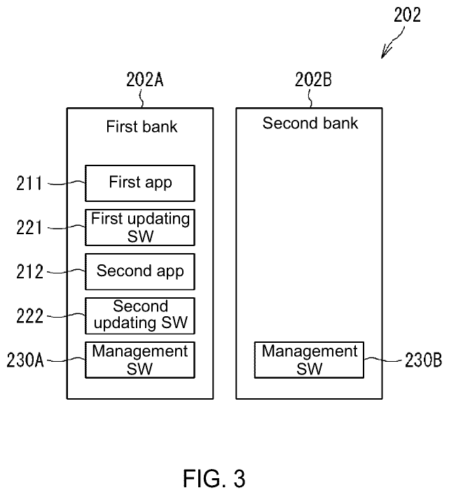

FIG. 3 is a block diagram depicting an example configuration of a nonvolatile memory installed in an ECU according to the first embodiment.

Data in the nonvolatile memory 202 is rewritable. That is, the nonvolatile memory 202 is a flash memory, a hard disk, or the like. This nonvolatile memory 202 is one example of a “storage unit” for the present disclosure.

As a specific example, the nonvolatile memory 202 is a dual bank memory. That is, the nonvolatile memory 202 includes a first bank 202A and a second bank 202B that are physically separated from each other. The first bank 202A and the second bank 202B are assigned respectively different memory areas (address spaces). The first bank 202A and the second bank 202B can operate independently of each other. That is, the first bank 202A and the second bank 202B can write and read data independently of each other. The first bank 202A is one example of a “first storage unit” for the present disclosure and the second bank 202B is one example of a “second storage unit”.

The nonvolatile memory 202 stores first application software 211, first updating software 221, second application software 212, second updating software 222, management software 230A, 230B, which are computer programs, and data used to execute such software. In the following description, “application software” is indicated as “APP” and “software” is indicated as “SW”. The functions of an ECU 200, which will be described later, are implemented by the processor 201 executing the first application software 211, the first updating software 221, the second application software 212, the second updating software 222, and the management software 230A and 230B.

As one example, the first APP 211 is application software for implementing the functions of one ECU. The second APP 212 is application software for implementing the functions of a different ECU to the first APP 211, for example. That is, the ECU 200 is an ECU in which the functions of two ECUs are integrated. The first APP 211 and the second APP 212 run on an operating system or a hypervisor (the “management SW 230A and 230B” described later). As one example, the first APP 211 is software for controlling headlights and the second APP 212 is an ECU for controlling door mirrors.

In the first embodiment, the first APP 211, the first updating SW 221, the second APP 212, the second updating SW 222, and the management SW 230A are stored in the first bank 202A. The management SW 230B is stored in the second bank 202B. The management SW 230A is one example of “first management software” for the present disclosure. The management SW 230B is one example of “second management software”.

The management SW 230A and the management SW 230B are different versions of the same software, for example. As one example, the management SW 230A is the latest version of the software, and the management SW 230B is an old version of the software. Only one of the management SW 230A and 230B is executed at the same time. As one example, the management SW 230A, which is the new version, is executed, and the management SW 230B, which is an old version, is stopped. When a new version of the management SW is released, the management SW 230B that is stopped is updated. The management SW 230A continues to operate while the management SW 230B is being updated. When the updating of the management SW 230B has been completed, the software in use is switched from the management SW 230A (which is now an old version of the software) to the management SW 230B (the latest version of the software). By doing so, downtime for the management SW due to updating can be shortened or eliminated.

Returning to FIG. 2, the processor 201 is a central processing unit (CPU), for example. However, the processor 201 is not limited to a CPU. The processor 201 may be a graphics processing unit (GPU). One specific example of the processor 201 is a multi-core processor. However, the processor 201 may be a single-core processor. The processor 201 is configured to be capable of executing a computer program. However, as other examples, the processor 201 may be an application specific integrated circuit (ASIC) or a programmable logic device, such as a field programmable gate array (FPGA).

The communication I/F 204 is a communication interface that complies with the communication protocol for a vehicle-mounted network mentioned above. As one example, the communication I/F 204 is a CAN interface. However, the communication I/F 204 may be an Ethernet interface.

The communication I/F 204 is connected to the communication bus 500. The communication I/F 204 enables the ECU 200 to communicate with other ECUs 200 and the external communication apparatus 300. By using the communication I/F 204, the ECU 200 is also capable of communicating with the server 400 via the external communication apparatus 300.

### Logical Areas of Nonvolatile Memory

The nonvolatile memory 202 includes an MPU (Memory Protection Unit) (not illustrated). One or a plurality of logical areas (partitions) can be created in the nonvolatile memory 202. The MPU restricts data exchanges between such partitions.

As examples, the management SW 230A and 230B are an operating system (OS) or a hypervisor. The management SW 230A and 230B support data exchanges between partitions, that is, “inter-partition communication”.

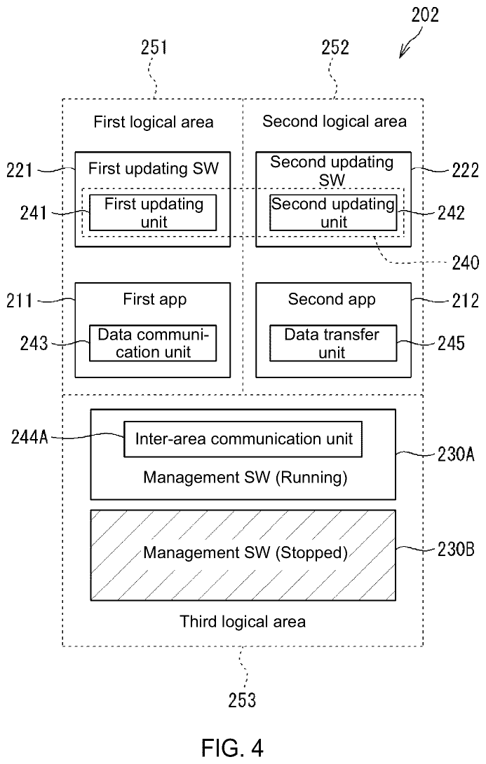

FIG. 4 is a diagram depicting the configuration of partitions in the nonvolatile memory according to the first embodiment.

The nonvolatile memory 202 includes a first logical area 251 and a second logical area 252. The first logical area 251 and the second logical area 252 are logically separated from each other. Data transfers between the first logical area 251 and the second logical area 252 are restricted by the MPU. The first logical area 251 and the second logical area 252 are both partitions.

The nonvolatile memory 202 further includes a third logical area 253. The third logical area 253 is also a partition that is logically separated from both the first logical area 251 and the second logical area 252. Data transfers between the third logical area 253 and the first logical area 251 are restricted by the MPU, and data transfers between the third logical area 253 and the second logical area 252 are also restricted by the MPU.

The first logical area 251, the second logical area 252, and the third logical area 253 are created by the functions of the management software 230A. The first logical area 251 is created in the first bank 202A described above. The second logical area 252 is also created in the first bank 202A. In other words, the first logical area 251 is a partial area of the first bank 202A, and the second logical area 252 is another partial area of the first bank 202A.

The third logical area 253 is provided across the first bank 202A and the second bank 202B. Part of the third logical area 253 is created in the first bank 202A, and another part of the third logical area 253 is created in the second bank 202B. In other words, the third logical area 253 includes part of the area of the first bank 202A and part of the area of the second bank 202B.

The first logical area 251 stores the first APP 211 and the first updating SW 221. The second logical area 252 stores the second APP 212 and the second updating SW 222. By storing the first APP 211 and the second APP 212 in different logical areas, interference between the first APP 211 and the second APP 212 can be prevented.

The management SW 230A and 230B are stored in the third logical area 253. In more detail, the management SW 230A is stored in an area of the first bank 202A within the third logical area 253, and the management SW 230B is stored in an area of the second bank 202B within the third logical area 253.

### Functions of ECUs

Next, the functions of each ECU 200 will be described.

The ECU 200 has the functions of an updating unit 240, a data communication unit 243, an inter-area communication unit 244A, and a data transfer unit 245.

The processor 201 executes the first APP 211 to implement the data communication unit 243. The data communication unit 243 transmits and receives data (frames) to and from the vehicle-mounted network 100. That is, the data communication unit 243 can transmit and receive frames to and from other ECUs 200, and can transmit and receive frames to and from the external communication apparatus 300.

The data communication unit 243 is a function that is implemented by executing the first APP 211 stored in the first logical area 251, and is a function that belongs to the first logical area 251.

The processor 201 executes the second APP 212 to implement a data transfer unit 245. The data transfer unit 245 can transfer data only to and from the inter-area communication unit 244A.

The data transfer unit 245 is a function that is implemented by executing the second APP 212 stored in the second logical area 252, and is a function that belongs to the second logical area 252.

The inter-area communication unit 244A is implemented by the processor 201 executing the management SW 230A. The inter-area communication unit 244A is a function of the management SW 230A that created the first logical area 251, the second logical area 252, and the third logical area 253, and is a function implemented by inter-partition communication.

Note that as described above, while the management SW 230A is being executed by the processor 201, the management SW 230B is not executed by the processor 201. In other words, the management SW 230B is in a stopped state. In FIG. 4, diagonal shading indicates the stopped state.

The inter-area communication unit 244A is able to receive data from the data communication unit 243 using the inter-partition communication function of the management SW 230A. In other words, the inter-area communication unit 244A can move data from the first logical area 251 to the third logical area 253. In addition, the inter-area communication unit 244A can pass data to the data communication unit 243 using the inter-partition communication function of the management SW 230A. In other words, the inter-area communication unit 244A can move data from the third logical area 253 to the first logical area 251.

The data communication unit 243 can transfer data only to and from the inter-area communication unit 244A. Data exchanges between the first logical area 251 and the second logical area 252 and data exchanges between the first logical area 251 and the third logical area 253 by the data communication unit 243 (that is, by the first APP 211) are both restricted (that is, prohibited) by the MPU. That is, the data communication unit 243 cannot move data from the first logical area 251 to the second logical area 252, and cannot move data from the second logical area 252 to the first logical area 251. In addition, the data communication unit 243 cannot move data from the first logical area 251 to the third logical area 253 and cannot move data from the third logical area 253 to the first logical area 251 without relying on the inter-area communication unit 244A.

The inter-area communication unit 244A can pass data to the data transfer unit 245 using the inter-partition communication function of the management SW 230A. In other words, the inter-area communication unit 244A can move data from the third logical area 253 to the second logical area 252. In addition, the inter-area communication unit 244A can receive data from the data transfer unit 245 using the inter-partition communication function of the management SW 230A. In other words, the inter-area communication unit 244A can move data from the second logical area 252 to the third logical area 253.

The data transfer unit 245 can transfer data only to and from the inter-area communication unit 244A. Data exchanges between the second logical area 252 and the first logical area 251 and data exchanges between the second logical area 252 and the third logical area 253 by the data transfer unit 245 (that is, by the second APP 212) are both restricted (prohibited) by the MPU. That is, the data transfer unit 245 cannot move data from the second logical area 252 to the first logical area 251 and cannot move data from the first logical area 251 to the second logical area 252. In addition, the data transfer unit 245 cannot move data from the second logical area 252 to the third logical area 253 and cannot move data from the third logical area 253 to the second logical area 252 without relying on the inter-area communication unit 244A.

The data communication unit 243 has a first defense function that defends against external attacks. The first defense function is implemented by the data communication unit 243 executing a first defense process. When the communication protocol used by the ECU 200 is CAN, the first defense process is a filtering function which for example classifies all frames aside from those containing specified CAN IDs as abnormal frames. When the communication protocol used by the ECU 200 is Ethernet, the first defense process is a firewall or packet filtering, for example.

The data transfer unit 245 has a second defense function that defends against external attacks. The second defense function is implemented by the data transfer unit 244 executing a second defense process. When the communication protocol used by the ECU 200 is CAN, the second defense process is a filtering function that detects the abnormal frames mentioned above, for example. When the communication protocol used by the ECU 200 is Ethernet, the second defense process is a firewall or packet filtering, for example.

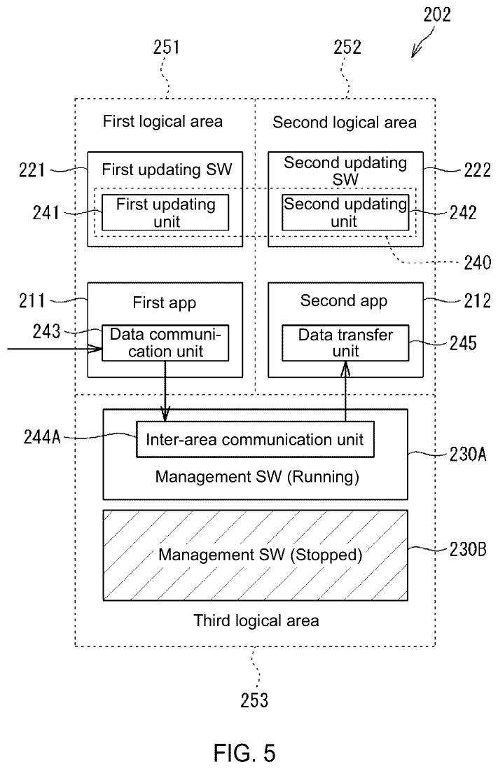

FIG. 5 is a diagram illustrating an example of a data flow in an ECU according to the first embodiment.

As one example, consider a case where the second APP 212 is software for controlling door mirrors. When a user (the driver) presses a switch to indicate folding away of the door mirrors, (a frame including) command data for folding away the door mirrors is transmitted from an external ECU 200 to the vehicle-mounted network 100.

The data communication unit 243 receives the command data and executes the first defense process. If an abnormality has been detected in the command data, the command data is discarded and an abnormality process, such as notifying the user of the abnormality, is executed.

If there is no abnormality in the command data, the inter-area communication unit 244A receives the command data from the data communication unit 243 and passes the command data to the data transfer unit 245.

The data transfer unit 245 receives the command data and executes the second defense process. If an abnormality has been detected in the command data, the command data is discarded and an abnormality process is executed.

If there is no abnormality in the command data, the command data is interpreted by (the processor 201 executing) the second APP 212 and the door mirrors are folded away.

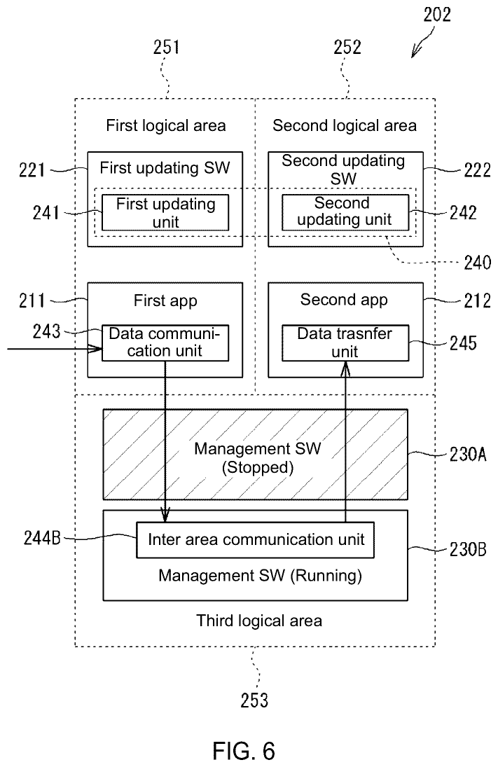

FIG. 6 is a diagram illustrating another example of a data flow in an ECU according to the first embodiment.

An inter-area communication unit 244B is implemented by the processor 201 executing the management SW 230B. The inter-area communication unit 244B is a function implemented by inter-partition communication by the management SW 230B.

Note that while the management SW 230B is being executed by the processor 201, the management SW 230A is not executed by the processor 201. In other words, the management SW 230A is in a stopped state.

The inter-area communication unit 244B has the same functions as the inter-area communication unit 244A. In other words, the inter-area communication unit 244B can move data from the first logical area 251 to the third logical area 253 using the inter-partition communication function of the management SW 230B. The inter-area communication unit 244A can also move data from the third logical area 253 to the first logical area 251 using the inter-partition communication function of the management SW 230B.

The inter-area communication unit 244B can move data from the third logical area 253 to the second logical area 252 using the inter-partition communication function of the management SW 230B. The inter-area communication unit 244B can move data from the second logical area 252 to the third logical area 253 using the inter-partition communication function of the management SW 230B.

When a user (the driver) has pressed a switch to indicate folding away of the door mirrors, (frames including) command data for folding away the door mirrors is transmitted from an external ECU 200 to the vehicle-mounted network 100.

The data communication unit 243 receives the command data and executes the first defense process. If an abnormality has been detected in the command data, the command data is discarded and an abnormality process is executed.

If there is no abnormality in the command data, the inter-area communication unit 244B receives the command data from the data communication unit 243 and passes the command data to the data transfer unit 245.

The data transfer unit 245 receives the command data and executes the second defense process. If an abnormality has been detected in the command data, the command data is discarded and an abnormality process is executed.

If there is no abnormality in the command data, the command data is interpreted by (the processor 201 executing) the second APP 212 and the door mirrors are folded away.

Returning to FIG. 4, the updating unit 240 is described next. The updating unit 240 includes a first updating unit 241 and a second updating unit 242.

The processor 201 executes the first updating SW 221 to implement the first updating unit 241. Like the data communication unit 243 described above, the first updating unit 241 cannot send or receive data to or from the second logical area 252. The first updating unit 241 can send or receive data to or from the third logical area 253 only via the inter-area communication unit 244A.

The processor 201 executes the second updating SW 222 to implement the second updating unit 242. Like the data communication unit 243 described above, the second updating unit 242 cannot send or receive data to or from the first logical area 251. The second updating unit 242 can send and receive data to and from the third logical area 253 only via the inter-area communication unit 244A.

The first updating unit 241 updates the first APP 211. The second updating unit 242 updates the second APP 212.

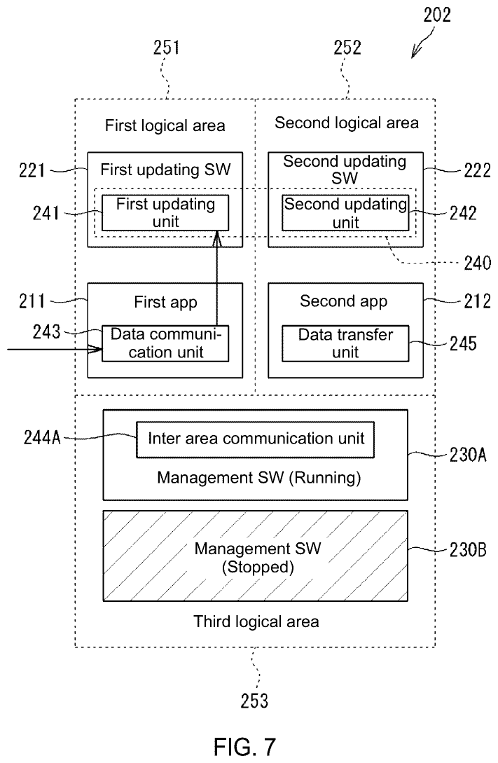

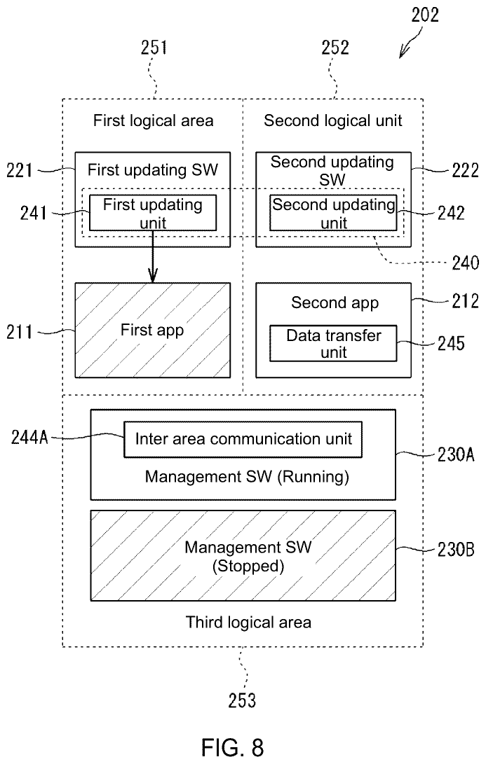

FIG. 7 is a diagram illustrating an example data flow when updating the first APP in an ECU according to the first embodiment, and FIG. 8 is a diagram illustrating updating of the first APP in an ECU according to the first embodiment.

As depicted in FIG. 7, when updating the first APP 211, update data (or “first update data”) for updating the first APP 211 is transmitted from the server 400 to the external communication apparatus 300. As one example, the external communication apparatus 300 divides the update data into a plurality of frames and transmits the respective frames to the target ECU 200.

The data communication unit 243 receives the frames, that is, the update data, transmitted from the external communication apparatus 300 and executes the first defense process. If an abnormality has been detected for a frame, the frames are discarded and an abnormality process is executed.

If there is no abnormality in the frames, the data communication unit 243 combines the data contained in each frame to restore the update data. The data communication unit 243 passes the update data to the first updating unit 241. The first updating unit 241 receives the update data from the data communication unit 243.

As depicted in FIG. 8, the first updating unit 241 uses the received update data to update the first APP 211. When the updating has been completed, the updated first APP 211 is restarted.

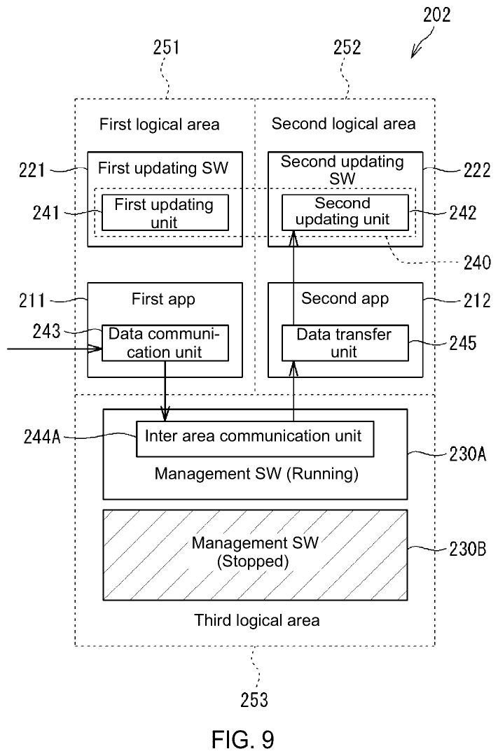

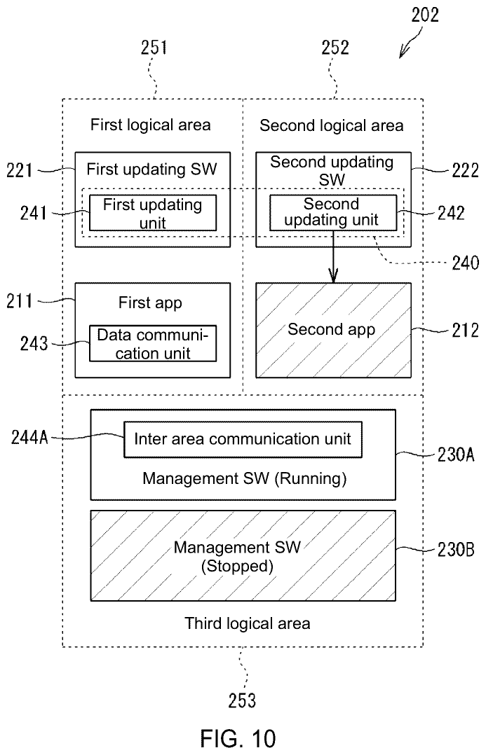

FIG. 9 is a diagram illustrating an example data flow when updating the second APP in an ECU according to the first embodiment, and FIG. 10 is a diagram illustrating the updating of the second APP in an ECU according to the first embodiment.

As depicted in FIG. 9, when updating the second APP 212, update data (or “second update data”) for updating the second APP 212 is transmitted from the server 400 to the external communication apparatus 300. As one example, the external communication apparatus 300 divides the update data into a plurality of frames and transmits the respective frames to the target ECU 200.

The data communication unit 243 receives the frames, that is, the update data, transmitted from the external communication apparatus 300 and executes a first defense process. If an abnormality has been detected for a frame, the frames are discarded and an abnormality process is executed.

If there is no abnormality in the frames, the data communication unit 243 combines the data contained in the frames to restore the update data. The inter-area communication unit 244A receives the update data from the data communication unit 243 and passes the update data to the data transfer unit 245.

The data transfer unit 245 receives the update data and executes the second defense process. If an abnormality has been detected in the update data, the update data is discarded and an abnormality process is executed.

If there is no abnormality in the update data, the second updating unit 242 receives the update data from the data transfer unit 245.

Note that although the update data is passed from the inter-area communication unit 244A to the second updating unit 242 via the data transfer unit 245 in this example, the present disclosure is not limited to this. As one example, the update data may be passed directly from the inter-area communication unit 244A to the second updating unit 242. In this case, the second updating unit 242 may have a defense function.

As depicted in FIG. 10, the second updating unit 242 uses the received update data to update the second APP 212. When the updating has been completed, the updated second APP 212 is restarted.

### Operation of ECU

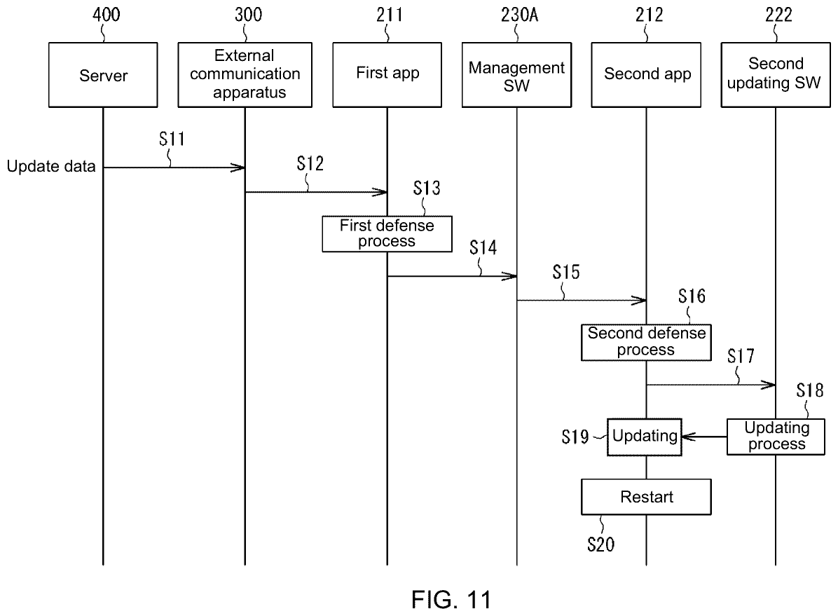

The operation of an ECU according to the first embodiment is described below. FIG. 11 is a sequence chart depicting data flows on the vehicle-mounted network when the second APP is updated at an ECU according to the first embodiment.

When the update data for the second APP 212 has been released, such update data is stored in the server 400. The server 400 transmits this update data for the second APP 212 to the external communication apparatus 300, as one example in response to a request from an ECU 200 (step S11).

When the external communication apparatus 300 has received the update data, the external communication apparatus 300 divides the data into a plurality of frames for example and transmits the respective frames to the target ECU 200 (step S12).

The processor 201 receives the frames transmitted from the external communication apparatus 300 using the functions of the first APP 211. The processor 201 executes the first defense process (step S13).

If there is no abnormality in the frames, the processor 201 restores the update data from the data included in the frames. The processor 201 transfers the update data from the first APP 211 to the management SW 230A (or 230B) using the inter-partition communication function of the management SW 230A (or 230B) (step S14).

In addition, the processor 201 transfers the update data from the management SW 230A (or 230B) to the second APP 212 using the inter-partition communication function of the management SW 230A (or 230B) (step S15).

The processor 201 executes the second defense process using the functions of the second APP 212 (step S16).

If there is no abnormality in the update data, the processor 201 transfers the update data from the second APP 212 to the second updating SW 222 (step S17).

Using the functions of the second updating SW 222, the processor 201 executes an updating process of the second APP 212 using the update data (step S18). By doing so, the second APP 212 is updated (step S19).

When the updating of the second APP 212 has been completed, the processor 201 restarts the second APP 212 (step S20).

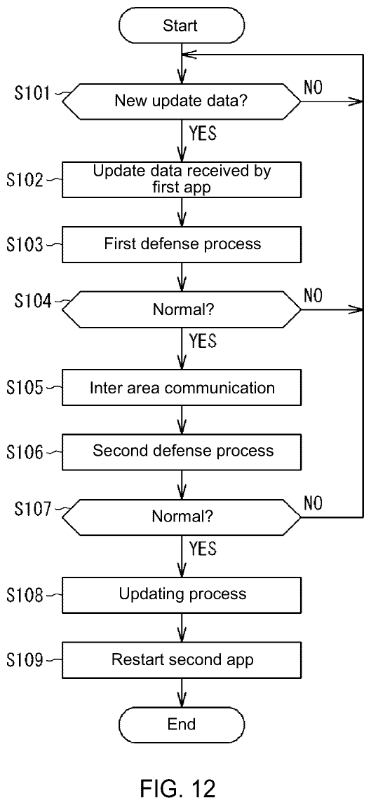

FIG. 12 is a flowchart depicting an example operation of an ECU according to the first embodiment when the ECU updates the second APP.

The processor 201 determines whether new update data for the second APP 212 exists, that is, whether the server 400 is able to provide new update data, based, for example, on an enquiry to the server 400 or the presence or absence of a notification from the server 400 (step S101).

If new update data does not exist (NO in step S101), the processor 201 executes step S101 again.

When new update data exists (YES in step S101), as one example, the processor 201 requests a download of the update data to the server 400. The server 400 performs a download of the update data, for example, in response to a request. The external communication apparatus 300 receives the update data, divides the data into a plurality of frames, and transmits the frames to the ECU 200.

The processor 201 receives the update data (frames) using the functions of the first APP 211 (step S102).

When the processor 201 has received a frame, the processor 201 executes the first defense process (step S103). The processor 201 determines whether an abnormality has been detected by the first defense process (step S104). If an abnormality has been detected (NO in step S104), as one example the processor 201 discards the received frames and executes an abnormality process. In this case, the processor 201 returns to step S101.

If no abnormality has been detected by the first defense process (YES in step S104), the processor 201 performs inter-area communication of update data using the inter-partition communication function of the management SW 230A (or 230B) (step S105). That is, the processor 201 transfers the update data from the first APP 211 stored in the first logical area 251 to the management SW 230A (or 230B) stored in the third logical area 253, and also transfers the update data from the management SW 230A (or 230B) to the second APP 212 stored in the second logical area 252.

When the second APP 212 receives the update data, the processor 201 executes the second defense process (step S106). The processor 201 determines whether an abnormality has been detected by the second defense process (step S107). If an abnormality has been detected (NO in step S107), as one example the processor 201 discards the received frames and executes an abnormality process. In this case, the processor 201 returns to step S101.

When an abnormality has not been detected by the second defense process (YES in step S107), the processor 201 transfers the update data from the second APP 212 to the second updating SW 222. In addition, using the functions of the second updating SW 222, the processor 201 updates the second APP 212 using the update data (step S108).

When the updating has been completed, the processor 201 restarts the second APP 212 (step S109).

### SECOND EMBODIMENT

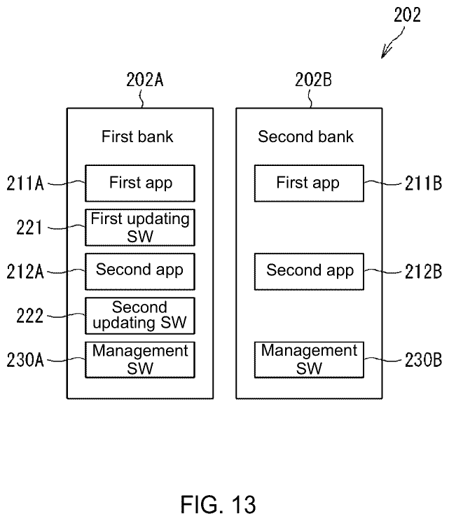

FIG. 13 is a block diagram depicting an example configuration of a nonvolatile memory installed in the ECU according to the second embodiment.

In this second embodiment, a first APP 211A is stored in the first bank 202A and a first APP 211B is stored in the second bank 202B.

As one example, the first APP 211A and the first APP 211B are different versions of the same software. The first APP 211A is the latest version of the software and the first APP 211B is an older version of the software, for example. Only one of the first APP 211A and 211B is executed at the same time. As one example, the first APP 211A, which is the new version, is executed and the first APP 211B, which is an old version, is stopped. When a new version of the first APP is released, the first APP 211B that is stopped is updated. The first APP 211A continues to operate while the first APP 211B is being updated. When the updating of the first APP 211B has been completed, the application in use is switched from the first APP 211A (which is now an old version of the software) to the first APP 211B (the latest version of the software). By doing so, downtime for the first APP due to updating can be shortened or eliminated.

In addition, a second APP 212A is stored in the first bank 202A, and a second APP 212B is stored in the second bank 202B.

In the same way as the first APPs 211A and 211B, the second APP 212A and the second APP 212B are different versions of the same software, for example. Only one of the second APPs 212A and 212B is executed at the same time. When a new version of the second APP has been released, the second APP 212B that is stopped is updated. The second APP 212A continues to operate even while the second APP 212B is being updated. When the updating of the second APP 212B has been completed, the application in use is switched from the second APP 212A (which is now an old version of the software) to the second APP 212B (the latest version of the software). By doing so, downtime for the second APP due to updating can be shortened or eliminated.

Since other parts of the configuration of an ECU according to the second embodiment are the same as the ECU 200 according to the first embodiment, description thereof is omitted.

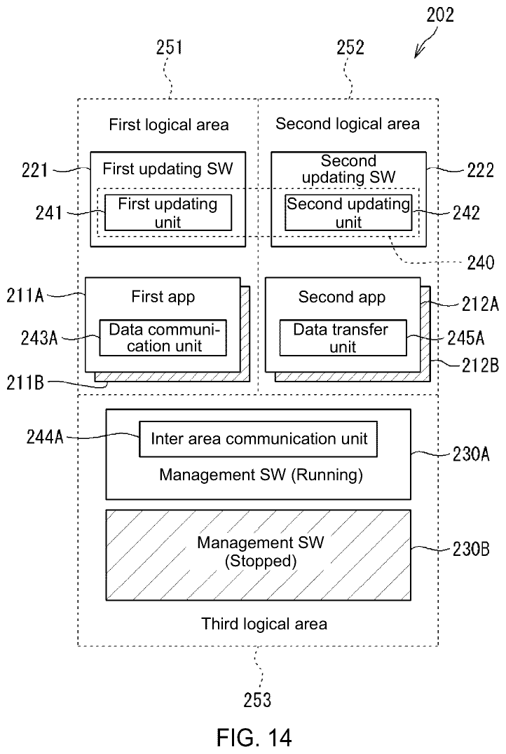

FIG. 14 is a diagram depicting the configuration of partitions in a nonvolatile memory according to the second embodiment.

A data communication unit 243A is implemented by the processor 201 executing the first APP 211A. The first APP 211A is the same software as the first APP 211 described above and the data communication unit 243A has the same functions as the data communication unit 243 described above.

A data transfer unit 245A is implemented by the processor 201 executing the second APP 212A. The second APP 212A is the same software as the second APP 212 described above, and the data transfer unit 245A has the same functions as the data transfer unit 245 described above.

As indicated by the diagonal shading in FIG. 14, the first APP 211B is in a stopped state and the second APP 212B is in a stopped state.

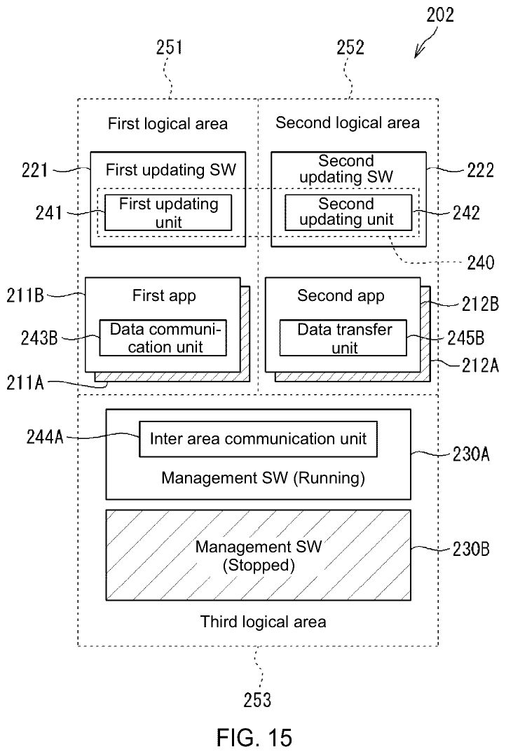

FIG. 15 is a diagram depicting the operating state of software when the application to be executed is switched between the first APP and the second APP.

As one example, when the first APP 211B is updated to a new version, the application to be executed is switched from the first APP 211A to the first APP 211B. That is, the first APP 211A is stopped and the first APP 211B is started. By executing the first APP 211B, the processor 201 implements a data communication unit 243B.

As one example, when the first APP 211B has been updated to a new version, the application to be executed is switched from the first APP 212A to the first APP 212B. That is, the second APP 212A is stopped and the first APP 212B is started. The processor 201 executes the second APP 212B to implement a data transfer unit 245B.

### THIRD EMBODIMENT

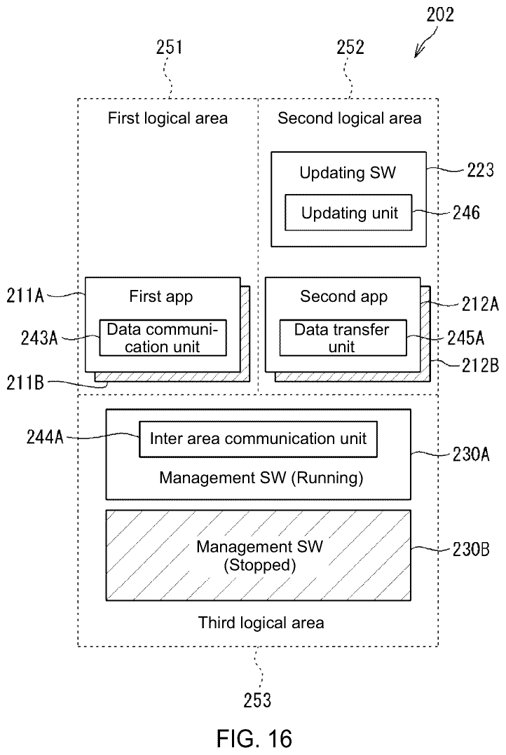

FIG. 16 is a block diagram depicting an example configuration of a nonvolatile memory installed in an ECU according to the third embodiment.

In the third embodiment, the first updating SW 221 is not stored in the first logical area 251, and an updating SW 223 is stored in the second logical area 252 in place of the second updating SW 222. Note that since the configuration of other parts of an ECU according to the third embodiment are the same as the configuration of the ECU 200 according to the second embodiment, components that are the same have been assigned the same reference numerals and description thereof is omitted.

The updating SW 223 is software for updating each of the first APPs 211A and 211B and the second APPs 212A and 212B.

This embodiment is described in more detail below. The processor 201 executes the updating SW 223 to implement an updating unit 246. The updating unit 246 can update each of the first APPs 211A and 211B and the second APPs 212A and 212B.

When updating the second APP 212B, update data for updating the second APP 212B (or “second update data”) is transmitted from the server 400 to the external communication apparatus 300. The external communication apparatus 300 divides the update data into a plurality of frames, for example, and transmits the frames to the target ECU 200.

The data communication unit 243A receives the frames, that is, the update data, transmitted from the external communication apparatus 300 and executes a first defense process. If an abnormality has been detected in a frame, the frames are discarded and an abnormality process is executed.

If there is no abnormality in the frames, the data communication unit 243A combines the data contained in the frames to restore the update data. The inter-area communication unit 244A receives the update data from the data communication unit 243A and passes the update data to the data transfer unit 245A.

The data transfer unit 245A receives the update data and executes the second defense process. If an abnormality has been detected in the update data, the update data is discarded and an abnormality process is executed.

If there is no abnormality in the update data, the updating unit 246 receives the update data from the data transfer unit 245A.

Note that although the update data is passed from the inter-area communication unit 244A to the updating unit 246 via the data transfer unit 245 in this example, the present embodiment is not limited to this. As one example, the update data may be passed directly from the inter-area communication unit 244A to the updating unit 246. In this case, the updating unit 246 may have a defense function.

The updating unit 246 uses the received update data to update the second APP 212B. When the updating has been completed, the second APP 212A is stopped and the updated second APP 212B is started.

When updating the first APP 211B, update data (or “first update data”) for updating the first APP 211B is transmitted from the server 400 to the external communication apparatus 300. The external communication apparatus 300 divides the update data into a plurality of frames, for example, and transmits the frames to the target ECU 200.

The data communication unit 243A receives the frames, that is, the update data, transmitted from the external communication apparatus 300 and executes a first defense process. If an abnormality has been detected in a frame, the frames are discarded and an abnormality process is executed.

If there is no abnormality in the frames, the data communication unit 243A combines the data contained in the frames to restore the update data. The inter-area communication unit 244A receives the update data from the data communication unit 243A and passes the update data to the data transfer unit 245A.

The data transfer unit 245A receives the update data and executes the second defense process. If an abnormality has been detected in the update data, the update data is discarded and an abnormality process is executed.

If there is no abnormality in the update data, the updating unit 246 receives the update data from the data transfer unit 245A.

The updating unit 246 updates the first APP 211B using the received update data.

Here, data communication between the first logical area 251 and the second logical area 252 is restricted. For this reason, it is possible for example for the updating unit 246 to divide the new first APP 211B into a plurality of pieces of data and send each piece of data to the first logical area 251 via the inter-area communication unit 244A. In the first logical area 251, a new first APP 211B can be created by combining the transmitted data. By doing so, the first APP 211B is updated.

When the updating has been completed, the first APP 211A is stopped and the updated first APP 211B is started.

### APPENDIX

The embodiments disclosed above are exemplary in all respects and should not be regarded as limitations on the present disclosure. The scope of the present invention is not limited to the embodiments given above, is indicated by the range of the patent claims, and is intended to include all changes within the meaning and scope of the patent claims and their equivalents.

1. A vehicle-mounted apparatus connected to a vehicle-mounted network, comprising:
a storage unit including a first logical area and a second logical area which are logically separated from each other and are subjected to restrictions on data transfers;
first software that is stored in the first logical area and is capable of transmitting and receiving data to and from the vehicle-mounted network;
second software that is stored in the second logical area and is subjected to restrictions on transmitting and receiving data to and from the vehicle-mounted network;
an updating unit that updates the second software; and
an inter-area communication unit that is capable of transmitting and receiving data to and from the first logical area and is also capable of transmitting and receiving data to and from the second logical area,
wherein the inter-area communication unit receives update data, which a data communication unit implemented by a processor executing the first software has received from the vehicle-mounted network, from the data communication unit and passes the received update data to the updating unit, and
the updating unit updates the second software based on the update data passed from the inter-area communication unit.

2. The vehicle-mounted apparatus according to claim 1, wherein the updating unit is implemented by the processor executing updating software stored in the second logical area.

3. The vehicle-mounted apparatus according to claim 2, wherein the updating unit is capable of updating the first software.

4. The vehicle-mounted apparatus according to claim 1,
wherein the updating unit includes a first updating unit that updates the first software and a second updating unit that updates the second software,
the first updating unit is implemented by the processor executing the first updating software stored in the first logical area, and
the second updating unit is implemented by the processor executing the second updating software stored in the second logical area.

5. The vehicle-mounted apparatus according to claim 4, wherein the first updating unit receives, from the data communication unit, first update data that was received by the data communication unit from the vehicle-mounted network, and updates the first software based on the received first update data.

6. The vehicle-mounted apparatus according to claim 1,
wherein the storage unit includes a first storage unit and a second storage unit that are physically separated,
the inter-area communication unit includes a first inter-area communication unit that is implemented by the processor executing first management software stored in the first storage unit and a second inter-area communication unit that is implemented by the processor executing second management software stored in the second storage unit,
the first inter-area communication unit operates while the second inter-area communication unit is stopped, and
the second inter-area communication unit operates while the first inter-area communication unit is stopped.

7. The vehicle-mounted apparatus according to claim 6,
wherein the first inter-area communication unit operates while the second management software is being updated, and
the second inter-area communication unit operates while the first management software is being updated.

8. The vehicle-mounted apparatus according to claim 6,
wherein the storage unit includes a third logical area that is logically separated from each of the first logical area and the second logical area and is subjected to restrictions on data transfers to and from each of the first logical area and the second logical area, and
the first management software and the second management software are stored in the third logical area.

9. The vehicle-mounted apparatus according to claim 6,
wherein the first logical area includes a first partial area of the first storage unit and a first partial area of the second storage unit,
the second logical area includes a second partial area of the first storage unit and a second partial area of the second storage unit,
the first software is stored in both the first partial area of the first storage unit and the first partial area of the second storage unit,
the first software stored in the first partial area of the second storage unit is stopped while the first software stored in the first partial area of the first storage unit is being executed, and
the first software stored in the first partial area of the first storage unit is stopped while the first software stored in the first partial area of the second storage unit is being executed.

10. The vehicle-mounted apparatus according to claim 9,
wherein the first software stored in the first partial area of the second storage unit is executed while the first software stored in the first partial area of the first storage unit is being updated, and
the first software stored in the first partial area of the first storage unit is executed while the first software stored in the first partial area of the second storage unit is being updated.

11. The vehicle-mounted apparatus according to claim 9,
wherein the second software is stored in both the second partial area of the first storage unit and the second partial area of the second storage unit,
the second software stored in the second partial area of the second storage unit is stopped while the second software stored in the second partial area of the first storage unit is being executed, and
the second software stored in the second partial area of the first storage unit is stopped while the second software stored in the second partial area of the second storage unit is being executed.

12. The vehicle-mounted apparatus according to claim 11,
wherein the second software stored in the second partial area of the second storage unit is executed while the second software stored in the second partial area of the first storage unit is being updated, and
the second software stored in the second partial area of the first storage unit is executed while the second software stored in the second partial area of the second storage unit is being updated.

13. The vehicle-mounted apparatus according to claim 1,
wherein the data communication unit has a first defense function that defends against external attacks, and
a data transfer unit implemented by the processor executing the second software has a second defense function that defends against external attacks.

14. An updating method for updating software in a vehicle-mounted apparatus connected to a vehicle-mounted network, comprising:
a step of receiving update data, which has been received from the vehicle-mounted network by a data communication unit implemented by a processor executing first software, which is stored in a first logical area provided in a storage unit and is capable of transmitting and receiving data to and from the vehicle-mounted network, using an inter-area communication unit capable of transmitting and receiving data to and from the first logical area;
a step of the inter-area communication unit passing the update data to an updating unit that updates second software stored in a second logical area, which is provided in the storage unit and is logically separated from the first logical area, the second software being subjected to restrictions on transmitting and receiving data to and from the vehicle-mounted network; and
a step of the updating unit updating the second software based on the update data passed from the inter-area communication unit.

15. An updating program for updating software in a vehicle-mounted apparatus connected to a vehicle-mounted network,
the updating program causing a computer, which includes a storage unit including a first logical area and a second logical area which are logically separated from each other and are subjected to restrictions on data transfers, to execute processing comprising:
a step of receiving update data, which has been received from the vehicle-mounted network by a data communication unit implemented by a processor executing first software, which is stored in the first logical area and is capable of transmitting and receiving data to and from the vehicle-mounted network, via an inter-area communication unit capable of transmitting and receiving data to and from the first logical area; and
a step of updating, based on the update data received from the inter-area communication unit, second software that is stored in the second logical area and is subject to restrictions on transmitting and receiving data to and from the vehicle-mounted network.
